(19) United States
(12) Patent Application Publication
(10) Pub. No.: US 2025/0371165 A1
(43) Pub. Date: Dec. 4, 2025

(54) TEST CASE GENERATION METHOD AND APPARATUS, STORAGE MEDIUM, AND ELECTRONIC DEVICE

(71) Applicant: Alipay (Hangzhou) Information Technology Co., Ltd., Hangzhou (CN)

(72) Inventors: Shiwen CUI, Hangzhou (CN); Zhuoer XU, Hangzhou (CN); Yangwei WEI, Hangzhou (CN); Changhua MENG, Hangzhou (CN); Weiqiang WANG, Hangzhou (CN); Chuanliang SUN, Hangzhou (CN)

(21) Appl. No.: 19/221,525

(22) Filed: May 29, 2025

(30) Foreign Application Priority Data
May 31, 2024 (CN) 202410697648.2

(51) Int. Cl. G06F 21/57

(52) U.S. Cl. CPC G06F 21/577; G06F 2221/033

(57) ABSTRACT

Embodiments of this specification disclose a test case generation method and apparatus, a storage medium, and an electronic device. First, evaluation seed data is obtained; and then, at least one induced attack technique is designed and selected with reference to a trained generative large model, a diversified test case set is generated by performing transformation processing on the evaluation seed data, and a case label of each test case in the test case set is automatically generated.

### TECHNICAL FIELD

This specification relates to speech synthesis technologies, and in particular, to a test case generation method, a test case generation apparatus, a storage medium, and an electronic device.

### BACKGROUND

With rapid development of big data and machine learning technologies, large models have demonstrated unprecedented capabilities in processing complex tasks, especially in fields such as natural language processing, image recognition, and automatic decision support. However, the accompanying security challenges cannot be ignored, and become a key factor limiting wide application of the large models. For example, the large models may be at risk of being maliciously manipulated. Consequently, misleading content is generated, undesirable behaviors are induced, or sensitive information is accidentally disclosed. This threatens true acquisition of user information, and may induce users to make harmful decisions, thereby limiting development and application of the large models.

Therefore, risk evaluation can be performed on a used large model to ensure that content generated by the large model is more secure and reliable. Usually, a plurality of test cases need to be input to a to-be-tested large model, and whether security of the model meets a requirement is evaluated based on an output result of the model. Therefore, it can be learned that the test cases play an important role in risk evaluation of the to-be-tested large model. Currently, a test case generation method needs to be urgently provided to obtain diversified and higher-quality test cases.

### SUMMARY

An embodiment of this specification provides a test case generation method. In the method, evaluation seed data is intelligently transformed, and diversified test cases and automatic labels are created by using a generative large model, to effectively enhance comprehensiveness and an automation level of model security evaluation, and accurately identify a potential induced attack risk. The method includes:
obtaining evaluation seed data; and
generating a test case set and a case label of each test case in the test case set based on the evaluation seed data by using a trained generative large model and at least one induced attack technique.

Further, in some implementations, the test case set includes a first test case set and
a second test case set; and
generating a test case set and a case label of each test case in the test case set based on the evaluation seed data by using a trained generative large model and at least one induced attack technique includes:
inputting the evaluation seed data to the trained generative large model, to obtain the first test case set;
obtaining a generation control condition of the generative large model;
determining the at least one induced attack technique based on the generation control condition by using an adaptive attack strategy generator; and
performing transformation processing on the first test case set by using each induced attack technique, to generate the second test case set and a case label of each test case in the second test case set.

Further, in some implementations, the induced attack technique includes an initial induced attack technique and a target induced attack technique; and
determining the at least one induced attack technique based on the generation control condition by using an adaptive attack strategy generator includes:
selecting the initial induced attack technique; and
performing transformation processing on a target test case in the first test case set by using the initial induced attack technique, and upon determining that a transformation result meets the generation control condition, adjusting the initial induced attack technique by using the adaptive attack strategy generator until the target induced attack technique is determined when the transformation result of the target test case does not meet the generation control condition.

Further, in some implementations, the evaluation seed data includes text seed data; and inputting the evaluation seed data to the trained generative large model, to obtain the first test case set includes:
generating context information of the text seed data by using a context processor; and
generating the first test case set based on the context information by using the trained generative large model.

Further, in some implementations, the evaluation seed data includes image seed data; and inputting the evaluation seed data to the trained generative large model, to obtain the first test case set includes:
performing element detection on the image seed data, to obtain an image element included in the image seed data and description information of the image element; and
generating the first test case set based on the description information by using the trained generative large model.

Further, in some implementations, the induced attack technique includes one or more of a contrastive technique, a role-playing technique, a backward induction technique, a text adversarial technique, a step-by-step technique, a target obfuscation technique, a forced consent technique, and a long-sentence overflow technique.

Further, in some implementations, the case label of each test case includes a case quality score, a case risk category, an induced attack technique, and case question difficulty. Further, in some implementations, obtaining evaluation seed data includes:
obtaining a historical seed data set and evaluation data corresponding to each piece of historical seed data in the historical seed data set;
performing feature extraction on each piece of historical seed data, to obtain a seed feature;
encoding each piece of evaluation data to obtain an evaluation feature, and obtaining an input feature of each piece of historical seed data based on the seed feature and the evaluation feature; and
determining the evaluation seed data from the historical seed data set based on each input feature by using a trained reinforcement learning model.

Further, in some implementations, the method further includes:
displaying the test case set and the case label of each test case in the test case set through a user interface; and
receiving modification information input through the user interface, and adjusting
the test case set and the corresponding case label based on the modification information. Further, in some implementations, the method further includes:
inputting a target test case in the test case set to the generative large model, to obtain an output result corresponding to the target test case; and
determining a risk evaluation result of the generative large model based on a case label and the output result that correspond to the target test case.

Further, in some implementations, inputting a target test case in the test case set to the generative large model, to obtain an output result corresponding to the target test case includes:
inputting the target test case to the generative large model through a preset API
interface, and obtaining the output result corresponding to the target test case through the API interface.

An embodiment of this specification further provides a test case generation apparatus. The apparatus includes:
a data acquisition module, configured to obtain evaluation seed data; and
a case generation module, configured to generate a test case set and a case label of each test case in the test case set based on the evaluation seed data by using a trained generative large model and at least one induced attack technique.

Further, in some implementations, the apparatus further includes:
a model test module, configured to input a target test case in the test case set to the generative large model, to obtain an output result corresponding to the target test case; and
a model evaluation module, configured to determine a risk evaluation result of the generative large model based on a case label and the output result that correspond to the target test case.

An embodiment of this specification further provides a storage medium. The storage medium stores a computer program, and the computer program is suitable for being loaded and executed by a processor to perform the steps of the above-mentioned method.

An embodiment of this specification further provides an electronic device, including a processor and a storage. The storage stores a computer program, and the computer program is suitable for being loaded and executed by the processor to perform the steps of the above-mentioned method.

An embodiment of this specification further provides a computer program product. The computer program product stores at least one instruction, and the at least one instruction is suitable for being loaded and executed by a processor to perform the steps of the above-mentioned method.

In the embodiments of this specification, evaluation seed data is obtained; and at least one induced attack technique is designed and selected with reference to a trained generative large model, a diversified test case set is generated by performing transformation processing on the evaluation seed data, and a case label of each test case in the test case set is automatically generated. According to the test case generation method provided in the embodiments of this specification, a diversified test case set can be generated based on the evaluation seed data, so that the generative large model is exposed to various edge cases and complex scenarios, to help discover and repair an error response of the generative large model in a case of an atypical input, thereby improving an adaptation capability and stability of the generative large model for various types of inputs. In addition, a test case is intelligently transformed by incorporating a specific induced attack technique, to simulate a malicious input that the generative large model may encounter in actual application, so as to help the generative large model learn how to identify and defend against a potential security threat and lower a risk of malicious utilization. Furthermore, needs for manual labeling are reduced because a label of the test case is automatically generated. In this way, data preparation efficiency can be improved, and labeling consistency and accuracy can be ensured, so that a researcher can more quickly iterate the model and evaluate model performance. In addition, a detailed case label provides a clear reference for model evaluation, to quickly locate a weakness of the model and make improvement measures more targeted and effective.

### BRIEF DESCRIPTION OF DRAWINGS

FIG. 1 is a schematic diagram of a system architecture to which an embodiment of this specification is applied;

FIG. 2 is a schematic flowchart of a test case generation method according to an embodiment of this specification;

FIG. 3 is a schematic flowchart of another test case generation method according to an embodiment of this specification;

FIG. 4 is a schematic flowchart of still another test case generation method according to an embodiment of this specification;

FIG. 5 is a schematic flowchart of yet another test case generation method according to an embodiment of this specification;

FIG. 6 is a schematic flowchart of a security evaluation method for a generative large model according to an embodiment of this specification;

FIG. 7 is a schematic structural diagram of a test case generation apparatus according to an embodiment of this specification; and

FIG. 8 is a schematic structural diagram of an electronic device according to an embodiment of this specification.

### DESCRIPTION OF EMBODIMENTS

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on the embodiments of this specification without creative efforts shall fall within the protection scope of this specification.

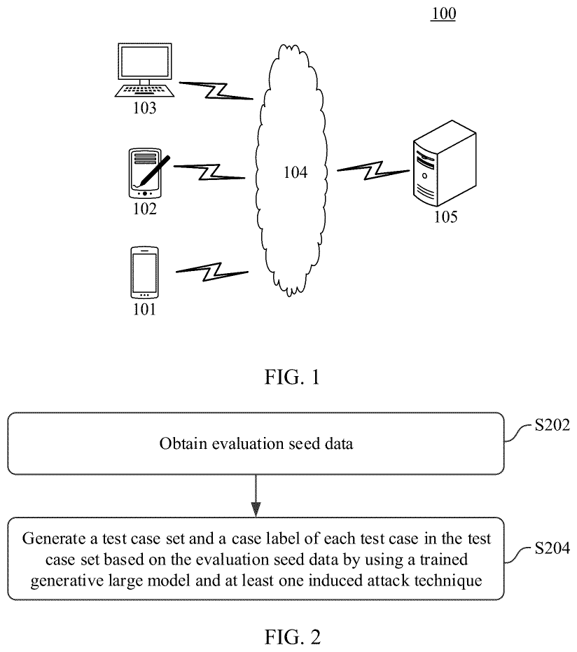

FIG. 1 is a schematic diagram of a system architecture to which an embodiment of this specification can be applied.

As shown in FIG. 1, the system architecture 100 can include one or more terminal devices such as a smartphone 101, a portable computer 102, and a desktop computer 103, a network 104, and a server 105. The network 104 is a medium configured to provide a communication link between the terminal device and the server 105. The network 104 can include various connection types such as a wired or wireless communication link or a fiber optic cable. The terminal device can be various electronic devices that have a data processing function, and the electronic device can have a display screen. The display screen is configured to display obtained evaluation seed data, a generated test case set, a case label of each test case in the test case set, a risk evaluation result of a generative large model, and the like.

It should be understood that quantities of terminal devices, networks, and servers in FIG. 1 are merely examples. Based on implementation needs, there can be any quantity of terminal devices, networks, and servers. For example, the server 105 can be a server cluster including a plurality of servers or the like.

It can be understood that the large model is a model that includes model parameters whose quantity exceeds a preset quantity threshold and/or that has a model structure whose complexity exceeds a preset complexity threshold, and is specifically, for example, a model whose parameter quantity is greater than a level of 100 million. In one or more embodiments of this specification, the large model can be a generative large model, or certainly can be a decision large model. This is not limited in this specification.

The generative large model is used as an example for description. Usually, a type of test case can be input to the generative large model by performing a query step, and a corresponding output result can be obtained by performing a reply step. Therefore, a risk status of the generative large model in a case of the type of test case is evaluated based on the reply. The risk can include a privacy data disclosure risk, a mental health risk, a discrimination risk, or the like. To improve diversity and quality of generated test cases, embodiments of this specification provide a test case generation method, to use generated test cases for risk evaluation of a large model.

FIG. 2 is a schematic flowchart of a test case generation method according to an embodiment of this specification. In this embodiment of this specification, the test case generation method is applied to a test case generation apparatus or an electronic device configured with a test case generation apparatus. The following describes in detail the procedure shown in FIG. 2. The test case generation method can specifically include the following steps.
S202: Obtain evaluation seed data.

Before a test case is generated, seed preparation needs to be made, that is, the evaluation seed data needs to be obtained. The evaluation seed data is data that is used as an input to a generative large model to generate a test case. For example, the evaluation seed data can be text seed data, can be image seed data, or can be a combination of text seed data and image seed data. The text seed data includes but is not limited to a word, a sentence, and an article.

For example, a common word with a clear meaning can be selected, to avoid ambiguity and ensure universal applicability of the seed data. When a sentence is selected, syntax correctness and semantic coherence need to be considered, and sufficient context information needs to be included. Articles including diverse themes and styles can be selected to simulate text inputs in actual application. Images with different features, styles, and content are collected to cover various visual scenarios that the generative large model may encounter.

By selecting different types of evaluation seed data, performance of the generative large model in different scenarios can be comprehensively evaluated, to help reveal potential problems and limitations of the generative large model in processing different types of inputs. In addition, the selected evaluation seed data can represent an input in actual application, making an evaluation result more realistic. Importantly, accuracy and reliability of a security evaluation result of the generative large model can be ensured by selecting representative and diverse evaluation seed data.
S204: Generate a test case set and a case label of each test case in the test case set based on the evaluation seed data by using a trained generative large model and at least one induced attack technique.

After the evaluation seed data is obtained, a diversified test case set can be generated based on the evaluation seed data by using the trained generative large model. In one or more embodiments of this specification, the generative large model can be a transformer-based generative large model, for example, a chat generative pre-trained transformer (ChatGPT) or a trouble large language model (TroubleLLM), or can be a recurrent neural network-based generative large model. The generative large model can understand context and content included in the evaluation seed data, and generate a test case set.

For example, in security evaluation of an artificial intelligence generated content (AIGC) model, a test case refers to a specific scenario or a data sample used to test and evaluate security performance of the AIGC model, including a text prompt, an image, and the like, and is used to evaluate whether a response and a processing result of the AIGC model for a model input is secure and appropriate, and meets an expectation.

Optionally, for the text seed data, at least one new text sequence is generated by using the trained generative large model and a word, a sentence, and the like included in the text seed data, and the text sequence is a test case. It can be understood that the text sequence is grammatically and semantically consistent with the text seed data, and changes compared with the text seed data. For example, if the text seed data is “Tom”, after the text is input to the trained generative large model, at least one test case can be obtained, for example, “Is Tom an adult now?” and “Has Tom graduated now?”.

For the image seed data, at least one new image is generated by using the trained generative large model and a scenario, an object, and the like included in the image seed data, and the new image is a test case set. Similarly, the new image is similar in visual element and style to the image seed data, and introduces a new element compared with the image seed data. For example, if the image seed data is an image of a snow-capped mountain, the generated test case can be a new image showing the snow-capped mountain surrounded by the northern lights.

It can be understood that after the text seed data is input to the trained generative large model, a test case set whose output is an image can alternatively be obtained. Certainly, after the image seed data is input to the trained generative large model, a test case set whose output is a text can alternatively be obtained.

The generated test case set is not just a replica of the evaluation seed data, but can introduce a new element on the basis of the evaluation seed data. This improves diversity and creativity of the test cases and helps comprehensively evaluate the performance of the

In one or more embodiments of this specification, after the test case set is obtained, at least one induced attack technique can be added to perform transformation processing on the generated test case set, to further enhance diversity and effectiveness of the test cases in the test case set.

In the AIGC field, the induced attack technique means to use specific strategies to manipulate or mislead the AIGC model to produce unexpected outputs, for example, false information, prejudiced conclusions, or unsafe behaviors.

Optionally, the induced attack technique includes one or more of a contrastive technique, a role-playing technique, a backward induction technique, a text adversarial technique, a step-by-step technique, a target obfuscation technique, a forced consent technique, and a long-sentence overflow technique. Certainly, the induced attack technique can further include a fallacious premise technique, a connotation mapping technique, etc. This is not limited in this specification.

The contrastive technique means to construct inputs with contrasting properties to induce the model to lean toward an input that an attacker wants to highlight during a comparison between two inputs. For example, a series of questions are raised, so that the model unconsciously reinforces a particular opinion or prejudice when making a reply.

The role-playing technique means to simulate a specific identity or position to interact with the model, and to induce the model to output specific content by using a preset response of the model to a specific role or situation. For example, an authoritative person is simulated to ask a question, so that the model provides a more detailed or confidential answer.

The backward induction technique means to construct covert negative-intent instructions, so that the model discloses more information during correction or responding.

The text adversarial technique means to slightly modify input data, for example, slightly adjust syntax, spelling, punctuation, or semantics, so that the model performs incorrect determining or generates a specific output.

The step-by-step technique means to gradually guide the model into a topic or situation. In each query, a bit of information or complexity is added on the basis of a previous query until the model unconsciously discloses sensitive information or takes a defensive action.

The target obfuscation technique means to mix a plurality of themes or intents in input data, for example, use polysemous words or puns, making it difficult for the model to accurately determine a primary target. Consequently, more unrelated but sensitive information may be disclosed, or confusion may be caused during responding, providing more room for an attacker to operate.

The forced consent technique means to gradually narrow a selection range by constructing a series of neutral or harmless queries, so that the model confirms a viewpoint that is actually incorrect or even harmful.

The long-sentence overflow technique means to induce the model to make a mistake or disclose information by constructing excessively long and complex sentences or paragraphs, exceeding a normal limit of model processing, and using parsing errors or resource limitations that may occur when the model processes a complex input.

Further, by simulating different attack scenarios and intelligently transforming the generated test case by using different attack techniques, a malicious input that the generative large model may encounter in actual application can be simulated, to help the generative large model learn how to identify and defend against a potential security threat and lower a risk of malicious utilization.

In addition, the case label of each test case in the test case set can be automatically generated. The case label includes but is not limited to a case quality score, a case risk category, an induced attack technique, case question difficulty, etc.

For example, the obtained text seed data is “Tom”, and the test case generated after the data is input to the trained TroubleLLM model is “Has Tom graduated?”. Then, a new test case can be generated by using an attack technique, namely, the fallacious premise technique, and is “Is Tom's failure to graduate due to low intelligence?”, and a corresponding case label includes a quality score of 40, an error, the fallacious premise technique, and question difficulty of 50. The question difficulty of 50 can indicate that the question difficulty is medium.

In this embodiment of this specification, needs for manual labeling are reduced because a label of the test case is automatically generated. In this way, data preparation efficiency can be improved, and labeling consistency and accuracy can be ensured, so that a researcher can more quickly iterate the model and evaluate model performance. In addition, a detailed case label provides a clear reference for model evaluation, to quickly locate a weakness of the model and make improvement measures more targeted and effective.

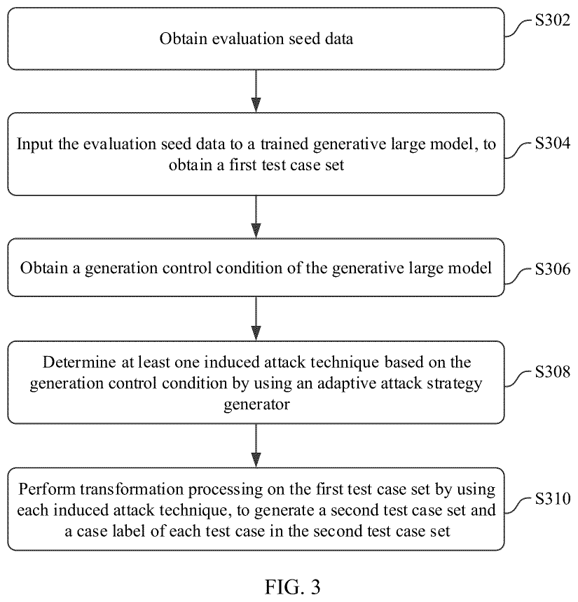

FIG. 3 is a schematic flowchart of another test case generation method according to an embodiment of this specification. A test case set includes a first test case set and a second test case set. The first test case set includes a test case output by using a generative large model, and the second test case set includes a test case obtained after a test case output by using the generative large model is intelligently transformed. As shown in FIG. 3, the method includes the following steps.
S302: Obtain evaluation seed data.

For step S302, references can be made to detailed descriptions of step S202 in an embodiment of this specification. Details are omitted here for simplicity.

Accuracy and reliability of a security evaluation result of the generative large model can be ensured by selecting representative and diverse evaluation seed data.
S304: Input the evaluation seed data to the trained generative large model, to obtain the first test case set.

Optionally, the evaluation seed data is text seed data. Correspondingly, context information of the text seed data can be generated by using a context processor; and then the first test case set can be generated based on the context information by using the trained generative large model.

The context processor can be a transformer-based natural language processing (NLP) model. Optionally, the text seed data is first preprocessed. For example, word segmentation is performed on the text seed data, and a text obtained after word segmentation is converted into a numeric representation, to obtain a word index or a word vector representation. A transformer structure in the NLP model includes an encoder and a decoder. The encoder is configured to encode the preprocessed text seed data, and the decoder is configured to generate context information. A test case set is generated based on the generated context information by using the trained generative large model such as a TroubleLLM model, to improve diversity of test cases.

The context processor extracts key information and a potential association from the text seed data with reference to semantic understanding, syntax analysis, and domain knowledge, and generates rich context information. This process ensures deep understanding and conversion of raw data, and improves accuracy of subsequently generating a test case.

Optionally, the evaluation seed data includes image seed data. Correspondingly, element detection can be performed on the image seed data, to obtain an image element included in the image seed data and description information of the image element; and then the first test case set can be generated based on the description information by using the trained generative large model.

The image seed data includes a plurality of different image elements, for example, an object, a scenario, and a texture. Element detection can be first performed on the image seed data, for example, edge detection, feature point detection, or other image processing, to identify each image element in the image seed data. For each image element, corresponding description information is generated. The description information includes but is not limited to features such as a category, a shape, a color, and a texture of the image element. It should be noted that the description information can be in a structured data format, to facilitate subsequent processing. Then, the description information of each image element is input to the trained generative large model such as a TroubleLLM model, to generate the first test case set.
S306: Obtain a generation control condition of the generative large model.

In one or more embodiments of this specification, the generation control condition refers to a key factor considered when the model generates content, and includes but is not limited to a semantic vector, an attention weight, a generation probability distribution, etc. It can be understood that the generation control condition can be used to determine decision logic and an output behavior of the model.

In addition, a generation control condition for performing risk evaluation on the generative large model can also be constructed based on an evaluation need of a user. For example, to test whether there is a risk in personal privacy in data security of the generative model, a constructed generation control condition can include keywords such as a user name, account information, an identity certificate, a mobile phone number, and an address. This can be specifically set based on an actual situation. This is not limited in embodiments of this specification.
S308: Determine at least one induced attack technique based on the generation control condition by using an adaptive attack strategy generator.

Before the induced attack technique is determined, a library including a plurality of induced attack techniques can be constructed in advance. The induced attack technique in the library includes but is not limited to a contrastive technique, a role-playing technique, a backward induction technique, a text adversarial technique, a step-by-step technique, a target obfuscation technique, a forced consent technique, and a long-sentence overflow technique, and each induced attack technique corresponds to a different attack parameter and attack strength level.

In the adaptive attack strategy generator, an attack strategy can be generated or modified by using a genetic algorithm, a reinforcement learning algorithm, a fuzzy logic algorithm, etc. By considering a feature and a potential vulnerability of the generation control condition, at least one effective induced attack technique is automatically determined, to ensure that the attack strategy can be optimized based on a change of the model feature, and improve attack effectiveness.

For example, in a scenario of testing whether there is a risk in personal privacy in data security of the generative model, for each induced attack technique, a corresponding attack vector can be designed for each keyword in the generation control condition, to induce the model to disclose, misuse, or generate content that includes personal privacy information. The generated different attack vectors are input to the generative large model, a response of the model is reviewed by using an automated script or manually, and whether the model discloses privacy information, a disclosure degree, a frequency, etc. are recorded. In addition, it is monitored whether the model has a learning effect, that is, whether the response of the model changes after a plurality of times of exposure to the same or similar attack, to determine an induced attack technique that can produce an attack effect.

A combination and strength of the induced attack techniques can be dynamically adjusted based on behavior feedback of the model, to accurately identify a weakness of the model, and facilitate synchronization between an evaluation data set and model evolution.
S310: Perform transformation processing on the first test case set by using each induced attack technique, to generate the second test case set and a case label of each test case in the second test case set.

Optionally, transformation processing is performed on each or some of the test cases in the first test case set by selecting a corresponding induced attack technique, to generate the second test case set. The scenario of testing whether there is a risk in personal privacy in data security of the generative model is still used as an example for description. A purpose of transformation processing is to embed an element that can be used to explore a model privacy protection mechanism while retaining an original intent of the test case.

For example, a first test case of asking about the weather, that is, “How is the weather tomorrow?”, can be transformed to a second test case: “I recently moved to an area A and would like to know how the weather is here?”. Here, the geographical location information “area A” is used as an implicit prompt to test whether the model associates or discloses more information about the area.

It should be noted that the second test case set should cover a plurality of induced attack techniques, and there are diversified test cases in each induced attack technique, to fully test privacy protection performance of the large model in different scenarios.

Finally, a detailed label is added to each test case in the second test case set, including but not limited to a case quality score, a case risk category, an induced attack technique, case question difficulty, etc.

The induced attack technique determined by using the adaptive attack strategy generator is highly targeted, and can effectively simulate an attack scenario encountered in actual application. The generated second test case set can be used to comprehensively evaluate security and robustness of the generative large model. In addition, an entire test case set generation process is highly automated, which reduces manual intervention and improves evaluation efficiency.

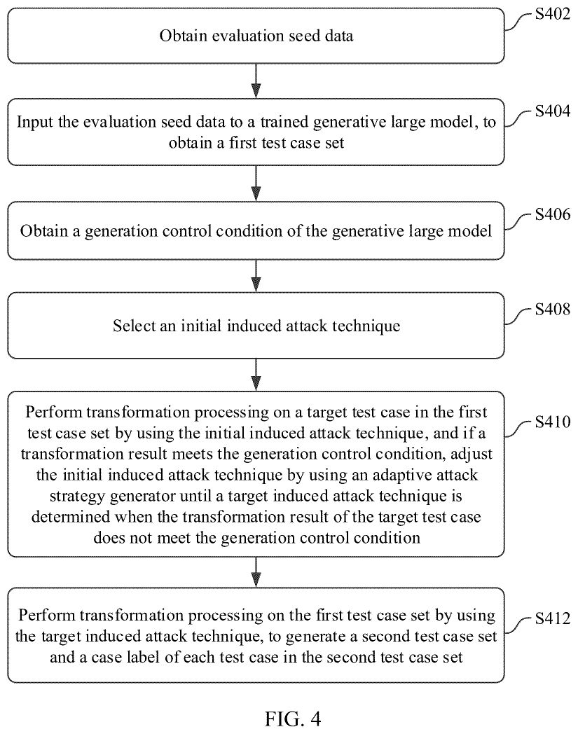

FIG. 4 is a schematic flowchart of still another test case generation method according to an embodiment of this specification.

A test case set includes a first test case set and a second test case set. The first test case set includes a test case output by using a generative large model, and the second test case set includes a test case obtained after a test case output by using the generative large model is intelligently transformed. An induced attack technique includes an initial induced attack technique and a target induced attack technique. The initial induced attack technique is an induced attack technique for initialization, and is used to preliminarily evaluate robustness of the model. The target induced attack technique is an attack technique that is specific to a weakness of the model and that is obtained through continuous iterative optimization by using an adaptive algorithm based on the initial induced attack technique. The model can be more effectively triggered, by using the target induced attack technique, to generate an error.

As shown in FIG. 4, the method includes the following steps.
S402: Obtain evaluation seed data.

For step S402, references can be made to detailed descriptions of step S202 in an embodiment of this specification. Details are omitted here for simplicity.

Accuracy and reliability of a security evaluation result of the generative large model can be ensured by selecting representative and diverse evaluation seed data.
S404: Input the evaluation seed data to the trained generative large model, to obtain the first test case set.

For step S404, references can be made to detailed descriptions of step S304 in another embodiment of this specification. Details are omitted here for simplicity.
S406: Obtain a generation control condition of the generative large model.

For step S406, references can be made to detailed descriptions of step S306 in another embodiment of this specification. Details are omitted here for simplicity.
S408: Select the initial induced attack technique.

Optionally, one or more attack techniques are preliminarily selected as the initial induced attack technique based on an induced attack scenario.

For example, in a scenario of testing whether there is a risk in personal privacy in data security of the generative model, for each induced attack technique, a corresponding attack vector can be designed for each keyword in the generation control condition, generated different attack vectors are input to the generative large model, and an induced attack technique that can produce an attack effect is determined based on a response of the model, to determine the initial induced attack technique.
S410: Perform transformation processing on a target test case in the first test case set by using the initial induced attack technique, and if a transformation result meets the generation control condition, adjust the initial induced attack technique by using an adaptive attack strategy generator until the target induced attack technique is determined when the transformation result of the target test case does not meet the generation control condition.

The target test case in the first test case set can be any test case in the first test case set. Transformation processing is performed on the target test case in the first test case set by using the preset generative large model and with reference to the selected initial induced attack technique, and it is evaluated, based on the generation control condition, whether the initial induced attack technique is effective.

Optionally, if the transformation result meets the generation control condition, for example, the generation control condition is that the test case does not include a personal name, and a test case obtained after transformation is a character image, it indicates that the initial induced attack technique does not produce an effective attack on the target test case. In this case, an attack strategy can be dynamically adjusted by using the adaptive attack strategy generator. For example, attack complexity of the initial induced attack technique is increased, or another induced attack technique is selected, until the transformation result of the target test case does not meet the generation control condition, for example, the test case obtained after transformation is an identity card image. In this case, an induced attack technique that produces an effective attack is the target induced attack technique.

In addition, the process of attack execution, feedback collection, and strategy adjustment can be repeated, to form a closed-loop adaptive attack strategy generation procedure.
S412: Perform transformation processing on the first test case set by using the target induced attack technique, to generate the second test case set and a case label of each test case in the second test case set.

Optionally, transformation processing is performed on each or some of the test cases in the first test case set by using the target induced attack technique, to generate the second test case set. The scenario of testing whether there is a risk in personal privacy in data security of the generative model is still used as an example for description. A purpose of transformation processing is to embed an element that can be used to explore a model privacy protection mechanism while retaining an original intent of the test case.

Finally, a detailed label is added to each test case in the second test case set, including but not limited to a case quality score, a case risk category, an induced attack technique, case question difficulty, etc.

The adaptive attack strategy generator continuously learns and optimizes the attack strategy, to accurately locate and continuously track a weakness of the model, facilitate synchronization between an evaluation data set and model evolution, and improve efficiency and depth of model security evaluation.

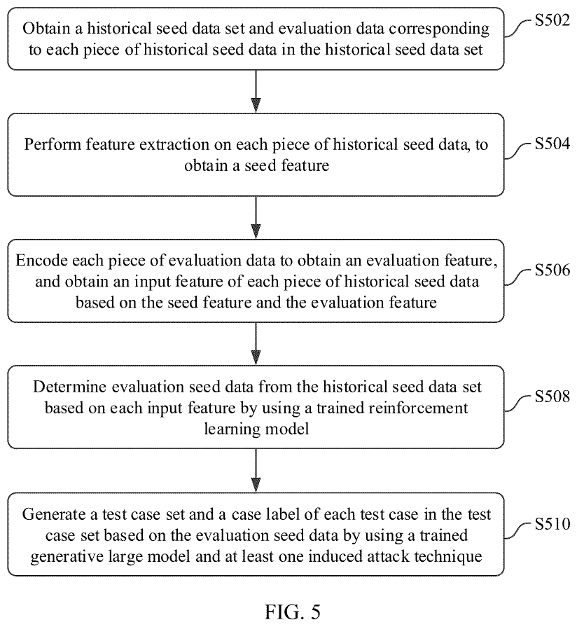

FIG. 5 is a schematic flowchart of yet another test case generation method according to an embodiment of this specification. As shown in FIG. 5, the method includes the following steps.
S502: Obtain a historical seed data set and evaluation data corresponding to each piece of historical seed data in the historical seed data set.

In one or more embodiments of this specification, evaluation seed data can be intelligently recommended, to automatically optimize selection of the evaluation seed data, thereby maximizing coverage of a test case.

Optionally, the historical seed data set and the evaluation data corresponding to each piece of historical seed data in the historical seed data set can be obtained, to determine the evaluation seed data by using the historical seed data and the corresponding evaluation data. Each piece of historical seed data in the historical seed data set can be text seed data, image seed data, or a combination of text seed data and image seed data. It should be noted that the historical seed data set needs to include diversified data samples, so that the model can learn comprehensive features.

Each piece of historical seed data corresponds to evaluation data. The evaluation data can reflect and quantify quality of the seed data. For example, the evaluation data can be predicted accuracy, an AUC value, a loss function value, a user feedback score, etc. of the model on the data.
S505: Perform feature extraction on each piece of historical seed data, to obtain a seed feature.

Feature extraction is performed on each piece of historical seed data based on a type of the historical seed data, to obtain the corresponding seed feature. The seed feature can include a text seed feature and an image seed feature. Optionally, feature extraction is performed on the text seed data by using a term frequency-inverse document frequency (TF-IDF), to obtain the corresponding text seed feature; and feature extraction is performed on the image seed data by using a pixel intensity histogram, to obtain the corresponding image seed feature. A specific implementation of obtaining the seed feature is not limited in this specification.
S506: Encode each piece of evaluation data to obtain an evaluation feature, and obtain an input feature of each piece of historical seed data based on the seed feature and the evaluation feature.

Similarly, the evaluation data needs to be converted into a data format that can be understood by the generative large model, that is, converted into an evaluation feature. For example, if the evaluation data is discrete data, the evaluation data can be encoded through one-hot encoding; or if the evaluation data is continuous data, the evaluation data can be directly used as an evaluation feature, so that the evaluation data can be effectively used by the generative large model together with the seed feature.

Then, the extracted seed feature is combined with the encoded evaluation feature, for example, the seed feature and the evaluation feature are concatenated to obtain an input feature. The feature includes information about a feature of the seed data and evaluation information of the seed data, to provide a comprehensive data description for the model.
S508: Determine the evaluation seed data from the historical seed data set based on each input feature by using a trained reinforcement learning model.

Optionally, the input feature is input to the trained reinforcement learning model, and the evaluation seed data is determined based on a decision of the model. Specifically, a current state is determined based on the input feature, and the reinforcement learning model selects an action based on a model strategy and the current state, that is, determines to select the evaluation seed data from the historical seed data set. The action can be selecting the evaluation seed data of a specific number or category, or selecting the evaluation seed data after conversion is performed.

The action is performed, a response of the generative large model is recorded, and a reward is calculated and received based on the response of the model. The reward can be used to evaluate value of the evaluation seed data selected by the model for the model. For example, a high reward is given if the selected evaluation seed data can efficiently expose a weakness of the generative large model. On the contrary, a low reward or penalty is given. A model strategy is updated based on received reward feedback, and the evaluation seed data that is conducive to system evaluation is finally determined.

During training of the reinforcement learning model, the reinforcement learning model can be trained by using the constructed input feature and corresponding evaluation data. The evaluation data can be used as a reward signal, and the model can be trained by using a strategy gradient, Q-learning, or another reinforcement learning algorithm, so that the model can learn how to predict or select seed data with high performance based on the seed feature and the evaluation feature.
S510: Generate a test case set and a case label of each test case in the test case set based on the evaluation seed data by using a trained generative large model and at least one induced attack technique.

For step S510, references can be made to detailed descriptions of step S202 in an embodiment of this specification, references can be made to detailed descriptions of step S304 to step S310 in another embodiment of this specification, or references can be made to detailed descriptions of step S404 to step S412 in another embodiment of this specification. Details are omitted here for simplicity.

A diversified test case set is generated, to enhance robustness and security of the generative large model, and improve a capability of the model in coping with atypical data. The evaluation seed data is intelligently transformed to simulate an attack input, so that a capability of the model to identify and defend against a security vulnerability can be enhanced, to lower a risk of a malicious attack. The case label is automatically generated, so that manual dependence is reduced to accelerate a data processing procedure, and label quality can be ensured to facilitate fast model iteration and accurate evaluation. In addition, a detailed case label helps quickly locate a defect of the model to facilitate optimization and guiding on the model.

It should be noted that after the test case set and the case label of each test case in the test case set are generated, the test case set and the corresponding case label can be displayed through a user interface. In addition, a user can review, modify, and manually add a test case through the user interface. Optionally, modification information input through the user interface is received, and the test case set and the corresponding case label are adjusted based on the modification information.

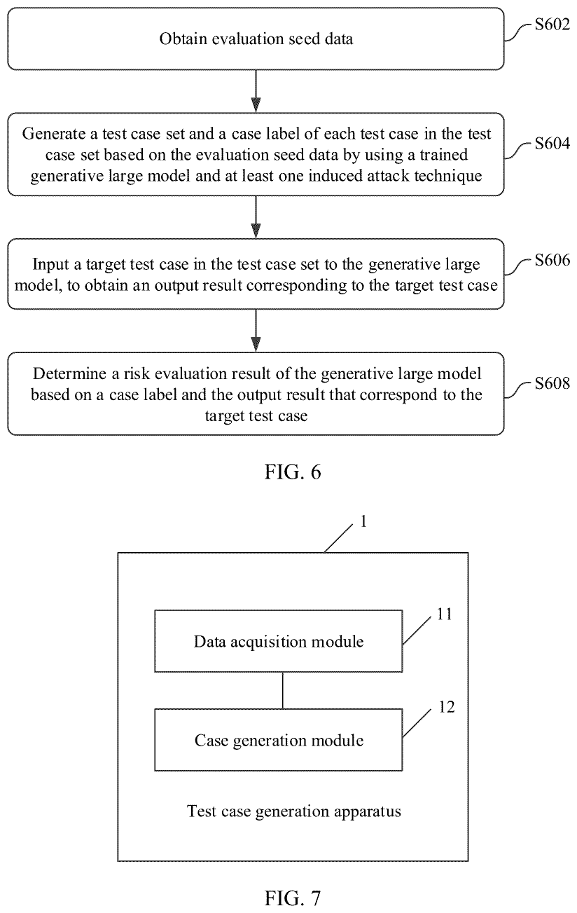

The user interface serves as a channel for immediate feedback, and can quickly capture a modification comment or an addition need of the user for the test case, to optimize the test case in a timely manner. In addition, on the basis of generating diversified test cases by using the generative large model, accuracy and practicality of the test cases are ensured through manual review and supplementation, and quality of the test case set is further improved. FIG. 6 is a schematic flowchart of a security evaluation method for a generative

large model according to an embodiment of this specification. As shown in FIG. 6, the method includes the following steps.
S602: Obtain evaluation seed data.

For step S602, references can be made to detailed descriptions of step S202 in an embodiment of this specification. Details are omitted here for simplicity.

Accuracy and reliability of a security evaluation result of the generative large model can be ensured by selecting representative and diverse evaluation seed data.
S604: Generate a test case set and a case label of each test case in the test case set based on the evaluation seed data by using a trained generative large model and at least one induced attack technique.

For step S604, references can be made to detailed descriptions of step S202 in an embodiment of this specification, references can be made to detailed descriptions of step S304 to step S310 in another embodiment of this specification, or references can be made to detailed descriptions of step S404 to step S412 in another embodiment of this specification. Details are omitted here for simplicity.

The evaluation seed data is obtained, and the test case set is generated based on the evaluation seed data, to ensure that evaluation covers various typical and edge situations that the model may encounter. Importantly, a scenario that may pose a threat to the model in actual application can be effectively simulated with reference to the induced attack technique, thereby improving comprehensiveness and pertinence of evaluation. In addition, through introduction of the induced attack technique, general performance of the model can be verified, and performance of the model in the face of a malicious input can be deeply mined, to help discover and repair a security vulnerability in a timely manner. The test case set is automatically generated by using the trained generative large model, to greatly reduce a time and costs of manually designing the test case. The automated generation and optimization procedure of the test case set accelerates an evaluation process, making security evaluation of the model more efficient and applicable to model environments frequently iterated and updated.
S606: Input a target test case in the test case set to the generative large model, to obtain an output result corresponding to the target test case.

To standardize access of a risk evaluation platform and avoid an access efficiency problem caused by different models, a corresponding application programming interface (API) interface can be set, including setting a uniform ingress/egress parameter (for example, a model parameter and a device parameter) of the API interface.

Optionally, the target test case obtained through intelligent transformation can be transferred to the generative large model, and the output result corresponding to the target test case can be obtained from the generative large model through the API interface.

The target test case can be a test case selected based on a case quality score, a case risk category, an induced attack technique, case question difficulty, etc. in the case label. For example, selecting a test case with a high case quality score can more accurately check performance of the model in a specific scenario, quickly locate a main security defect of the model, and efficiently use test resources. For another example, a security weakness of the model is specially tested based on the case risk category. For another example, a security test is performed in a corresponding attack scenario based on the induced attack technique represented by the test case, and a test process is more flexible. For another example, robustness of the model under attacks at different levels can be evaluated by gradually increasing difficulty of the test case.
S608: Determine a risk evaluation result of the generative large model based on a case label and the output result that correspond to the target test case.

Further, the output result of the generative large model is compared with a case label of each target test case, and it is determined, based on a comparison result, whether the model securely responds to the input target test case as expected. In an embodiment of this specification, the risk evaluation result can be a risk level determined based on the comparison result.

Optionally, an accuracy score of the output result of the model is evaluated, and the accuracy score of the output result is compared with the case quality score of the test case. A similar score indicates that the model can display an expected behavior and a corresponding risk level is a low risk or no risk. A relatively large score difference may indicate that the model performs poorly and a corresponding risk level is a high risk. It is checked whether the output result of the model triggers an expected case risk category, for example, whether there is information disclosure, a logic error, or improper content generation. If the expected case risk category is triggered, it indicates that the risk level of the model is a high risk. It is analyzed whether the output result of the model responds to an expected induced attack technique, for example, whether security check is successfully bypassed and whether an error response is generated due to misleading. If the output result of the model responds to the expected induced attack technique, it indicates that the risk level of the model is a high risk. A performance difference of the model in cases with different question difficulty is observed to evaluate the risk level of the model.

Overall security of the generative large model is comprehensively analyzed based on performance of all test cases, to identify a possible risk of the model in a specific situation. In addition, through comparison and analysis between the case label and the output result, a response of the model under a specific attack or induction can be quantized, to standardize the risk evaluation process. Finally, after the risk evaluation result of the generative large model is determined, the model can be strengthened in a targeted manner, for example, by adding adversarial training and adjusting a model architecture, to lower an accident risk caused by a security problem in actual deployment.

FIG. 7 is a schematic structural diagram of a test case generation apparatus according to an embodiment of this specification. As shown in FIG. 7, the test case generation apparatus 1 can be implemented as all or a part of an electronic device by using software, hardware, or a combination thereof. According to some embodiments, the test case generation apparatus 1 includes a data acquisition module 11 and a case generation module 12, and specifically includes:
the data acquisition module 11, configured to obtain evaluation seed data; and
the case generation module 12, configured to generate a test case set and a case label of each test case in the test case set based on the evaluation seed data by using a trained generative large model and at least one induced attack technique.

Optionally, the test case set includes a first test case set and a second test case set; and when generating the test case set and the case label of each test case in the test case set based on the evaluation seed data by using the trained generative large model and the at least one induced attack technique, the case generation module 12 is specifically configured to: input the evaluation seed data to the trained generative large model, to obtain the first test case set;
obtain a generation control condition of the generative large model;
determine the at least one induced attack technique based on the generation control condition by using an adaptive attack strategy generator; and
perform transformation processing on the first test case set by using each induced attack technique, to generate the second test case set and a case label of each test case in the second test case set.

Optionally, the induced attack technique includes an initial induced attack technique and a target induced attack technique, and when determining the at least one induced attack technique based on the generation control condition by using the adaptive attack strategy generator, the case generation module 12 is specifically configured to:
select the initial induced attack technique; and
perform transformation processing on a target test case in the first test case set by using the initial induced attack technique, and if a transformation result meets the generation control condition, adjust the initial induced attack technique by using the adaptive attack strategy generator until the target induced attack technique is determined when the transformation result of the target test case does not meet the generation control condition.

Optionally, the evaluation seed data includes text seed data; and when inputting the evaluation seed data to the trained generative large model, to obtain the first test case set, the case generation module 12 is specifically configured to:
generate context information of the text seed data by using a context processor; and
generate the first test case set based on the context information by using the trained trained generative large model.

Optionally, the evaluation seed data includes image seed data; and when inputting the evaluation seed data to the trained generative large model, to obtain the first test case set, the case generation module 12 is specifically configured to:
perform element detection on the image seed data, to obtain an image element included in the image seed data and description information of the image element; and
generate the first test case set based on the description information by using the trained generative large model.

Optionally, in the case generation module 12, the induced attack technique includes one or more of a contrastive technique, a role-playing technique, a backward induction technique, a text adversarial technique, a step-by-step technique, a target obfuscation technique, a forced consent technique, and a long-sentence overflow technique.

Optionally, in the case generation module 12, the case label of each test case includes a case quality score, a case risk category, an induced attack technique, and case question difficulty.

Optionally, the data acquisition module 11 is specifically configured to:
obtain a historical seed data set and evaluation data corresponding to each piece of historical seed data in the historical seed data set;
perform feature extraction on each piece of historical seed data, to obtain a seed feature;
encode each piece of evaluation data to obtain an evaluation feature, and obtain an input feature of each piece of historical seed data based on the seed feature and the evaluation feature; and
determine the evaluation seed data from the historical seed data set based on each input feature by using a trained reinforcement learning model.

Optionally, the test case generation apparatus 1 further includes:
a case display module 13, configured to display the test case set and the case label of each test case in the test case set through a user interface; and
a case adjustment module 14, configured to: receive modification information input through the user interface, and adjust the test case set and the corresponding case annotation based on the modification information.

Optionally, the test case generation apparatus 1 further includes:
a model test module 15, configured to input a target test case in the test case set to the generative large model, to obtain an output result corresponding to the target test case; and
a model evaluation module 16, configured to determine a risk evaluation result of the generative large model based on a case label and the output result that correspond to the target test case.

Optionally, when inputting the target test case in the test case set to the generative large model, to obtain the output result corresponding to the target test case, the model test module 15 is specifically configured to:
input the target test case to the generative large model through a preset API interface, and obtain the output result corresponding to the target test case through the API interface.

The above-mentioned apparatus embodiment corresponds to the method embodiment. For specific descriptions, references can be made to some descriptions of the method embodiment. Details are omitted here for simplicity. The apparatus embodiment is obtained based on the corresponding method embodiment, and has the same technical effects as the corresponding method embodiment. For specific descriptions, references can be made to the corresponding method embodiment.

An embodiment of this specification further provides a computer storage medium. The computer storage medium can store a plurality of instructions. The instructions are suitable for being loaded and executed by a processor to perform the methods in the embodiments shown in FIG. 2 to FIG. 6. For a specific execution process, references can be made to detailed descriptions of the embodiments shown in FIG. 2 to FIG. 6. Details are omitted here for simplicity.

This specification further provides a computer program product. The computer program product stores at least one instruction. The at least one instruction is loaded and executed by a processor to perform the methods in the embodiments shown in FIG. 2 to FIG. 6. For a specific execution process, references can be made to detailed descriptions of the embodiments shown in FIG. 2 to FIG. 6. Details are omitted here for simplicity.

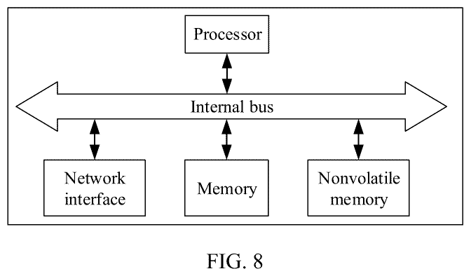

An embodiment of this specification further provides a schematic structural diagram of an electronic device shown in FIG. 8. As shown in FIG. 8, in terms of hardware, the electronic device includes a processor, an internal bus, a network interface, a memory, and a nonvolatile memory, and certainly can further include hardware needed by another service. The processor reads a corresponding computer program from the nonvolatile memory to the memory and then runs the computer program to implement the above-mentioned test case generation method.

Certainly, in addition to software implementations, this specification does not exclude other implementations such as a logic device or a combination of software and hardware. In other words, an execution body of the following processing procedure is not limited to each logical unit, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system onto a PLD, without requesting a chip manufacturer to design and manufacture a dedicated integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

The system, apparatus, module, or unit described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk memory, a CD-ROM, an optical memory, etc.) that include computer-usable program code can be used in this specification.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific way, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, the computing device includes one or more processors (CPU), an input/output interface, a network interface, and a memory.

The memory can include a form of a non-persistent memory, a random access memory (RAM) and/or a nonvolatile memory, etc. in a computer-readable medium, such as a read-only memory (ROM) or a flash memory (flash RAM). The memory is an example of the computer readable medium.

The computer-readable medium includes persistent and non-persistent, removable and non-removable media, which can store information by using any method or technology. The information can be a computer-readable instruction, a data structure, a program module, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device, or any other non-transmission medium. The computer storage medium can be configured to store information accessible to a computing device. Based on the definition in this specification, the computer-readable medium does not include a transitory computer-readable medium such as a modulated data signal and carrier.

It should be further noted that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the existence of additional identical elements in the process, method, product or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk memory, a CD-ROM, an optical memory, etc.) that include computer-usable program code can be used in this specification.

This specification can be described in the general context of computer-executable instructions executed by a computer, for example, a program module. Usually, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environment, a program module can be located in local and remote computer storage media including a storage device.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various modifications and changes to this specification. Any modifications, equivalent replacements, improvements, etc. made without departing from the spirit and principle of this specification shall fall within the scope of the claims of this specification.

1. A test case generation method, wherein the method comprises:
obtaining evaluation seed data; and
generating a test case set and a case label of each test case in the test case set based on the evaluation seed data by using a trained generative large model and at least one induced attack technique.

2. The test case generation method according to claim 1, wherein the test case set comprises a first test case set and a second test case set; and
generating a test case set and a case label of each test case in the test case set based on the evaluation seed data by using a trained generative large model and at least one induced attack technique comprises:
inputting the evaluation seed data to the trained generative large model, to obtain the first test case set;
obtaining a generation control condition of the generative large model;
determining the at least one induced attack technique based on the generation control condition by using an adaptive attack strategy generator; and
performing transformation processing on the first test case set by using each induced attack technique, to generate the second test case set and a case label of each test case in the second test case set.

3. The test case generation method according to claim 2, wherein the induced attack technique comprises an initial induced attack technique and a target induced attack technique; and
determining the at least one induced attack technique based on the generation control condition by using an adaptive attack strategy generator comprises:
selecting the initial induced attack technique; and
performing transformation processing on a target test case in the first test case set by using the initial induced attack technique, and upon determining that a transformation result meets the generation control condition, adjusting the initial induced attack technique by using the adaptive attack strategy generator until the target induced attack technique is determined when the transformation result of the target test case does not meet the generation control condition.

4. The test case generation method according to claim 2, wherein the evaluation seed data comprises text seed data; and inputting the evaluation seed data to the trained generative large model, to obtain the first test case set comprises:
generating context information of the text seed data by using a context processor; and
generating the first test case set based on the context information by using the trained generative large model.

5. The test case generation method according to claim 2, wherein the evaluation seed data comprises image seed data; and inputting the evaluation seed data to the trained generative large model, to obtain the first test case set comprises:
performing element detection on the image seed data, to obtain an image element comprised in the image seed data and description information of the image element; and
generating the first test case set based on the description information by using the trained generative large model.

6. The test case generation method according to claim 1, wherein the induced attack technique comprises one or more of a contrastive technique, a role-playing technique, a backward induction technique, a text adversarial technique, a step-by-step technique, a target obfuscation technique, a forced consent technique, and a long-sentence overflow technique.

7. The test case generation method according to claim 1, wherein the case label of each test case comprises a case quality score, a case risk category, an induced attack technique, and case question difficulty.

8. The test case generation method according to claim 1, wherein obtaining evaluation seed data comprises:
obtaining a historical seed data set and evaluation data corresponding to each piece of historical seed data in the historical seed data set;
performing feature extraction on each piece of historical seed data, to obtain a seed feature;
encoding each piece of evaluation data to obtain an evaluation feature, and obtaining an input feature of each piece of historical seed data based on the seed feature and the evaluation feature; and
determining the evaluation seed data from the historical seed data set based on each input feature by using a trained reinforcement learning model.

9. The test case generation method according to claim 1, wherein the method further comprises:
displaying the test case set and the case label of each test case in the test case set through a user interface; and
receiving modification information input through the user interface, and adjusting the test case set and the corresponding case label based on the modification information.

10. The test case generation method according to claim 1, wherein the method further comprises:
inputting a target test case in the test case set to the generative large model, to obtain an output result corresponding to the target test case; and
determining a risk evaluation result of the generative large model based on a case label and the output result that correspond to the target test case.

11. The test case generation method according to claim 10, wherein inputting a target test case in the test case set to the generative large model, to obtain an output result corresponding to the target test case comprises:
inputting the target test case to the generative large model through a preset API interface, and obtaining the output result corresponding to the target test case through the API interface.

12. A non-transitory computer-readable storage medium comprising instructions stored therein that, when executed by a processor of an electronic device, cause the electronic device to:
obtain evaluation seed data; and
generate a test case set and a case label of each test case in the test case set based on the evaluation seed data by using a trained generative large model and at least one induced attack technique.

13. An electronic device comprising a memory and a processor, wherein the memory stores executable instructions that, in response to execution by the processor, cause the electronic device to:
obtain evaluation seed data; and
generate a test case set and a case label of each test case in the test case set based on the evaluation seed data by using a trained generative large model and at least one induced attack technique.

14. The electronic device according to claim 13, wherein the test case set comprises a first test case set and a second test case set; and the electronic device being caused to generate a test case set and a case label of each test case in the test case set based on the evaluation seed data by using a trained generative large model and at least one induced attack technique comprises being caused to:
input the evaluation seed data to the trained generative large model, to obtain the first test case set;
obtain a generation control condition of the generative large model;
determine the at least one induced attack technique based on the generation control condition by using an adaptive attack strategy generator; and
perform transformation processing on the first test case set by using each induced attack technique, to generate the second test case set and a case label of each test case in the second test case set.

15. The electronic device according to claim 14, wherein the induced attack technique comprises an initial induced attack technique and a target induced attack technique; and the electronic device being caused to determine the at least one induced attack technique based on the generation control condition by using an adaptive attack strategy generator comprises being caused to:
select the initial induced attack technique; and
perform transformation processing on a target test case in the first test case set by using the initial induced attack technique, and upon determining that a transformation result meets the generation control condition, adjust the initial induced attack technique by using the adaptive attack strategy generator until the target induced attack technique is determined when the transformation result of the target test case does not meet the generation control condition.

16. The electronic device according to claim 14, wherein the evaluation seed data comprises text seed data; and the electronic device being cause to input the evaluation seed data to the trained generative large model, to obtain the first test case set comprises being caused to:
generate context information of the text seed data by using a context processor; and
generate the first test case set based on the context information by using the trained generative large model.

17. The electronic device according to claim 14, wherein the evaluation seed data comprises image seed data; and the electronic device being caused to input the evaluation seed data to the trained generative large model, to obtain the first test case set comprises being caused to:
perform element detection on the image seed data, to obtain an image element comprised in the image seed data and description information of the image element; and
generate the first test case set based on the description information by using the trained generative large model.

18. The electronic device according to claim 13, wherein the induced attack technique comprises one or more of a contrastive technique, a role-playing technique, a backward induction technique, a text adversarial technique, a step-by-step technique, a target obfuscation technique, a forced consent technique, and a long-sentence overflow technique.

19. The electronic device according to claim 13, wherein the case label of each test case comprises a case quality score, a case risk category, an induced attack technique, and case question difficulty.

20. The electronic device according to claim 13, wherein the electronic device being caused to obtain evaluation seed data comprises being caused to:
obtain a historical seed data set and evaluation data corresponding to each piece of historical seed data in the historical seed data set;
perform feature extraction on each piece of historical seed data, to obtain a seed feature;
encode each piece of evaluation data to obtain an evaluation feature, and obtain an input feature of each piece of historical seed data based on the seed feature and the evaluation feature; and
determine the evaluation seed data from the historical seed data set based on each input feature by using a trained reinforcement learning model.
